(19) United States
(12) Patent Application Publication
(10) Pub. No.: US 2026/0028201 A1
(43) Pub. Date: Jan. 29, 2026

(54) TAMPING APPARATUS, POST-PROCESSING APPARATUS, AND IMAGE FORMING APPARATUS

(71) Applicant: FUJIFILM Business Innovation Corp., Tokyo (JP)

(72) Inventors: Yuki MIZUNO, Kanagawa (JP); Eri FUKUI, Kanagawa (JP); Koji KAWANO, Kanagawa (JP)

(73) Assignee: FUJIFILM Business Innovation Corp., Tokyo (JP)

(21) Appl. No.: 19/051,838

(22) Filed: Feb. 12, 2025

(30) Foreign Application Priority Data
Jul. 16, 2024 (JP) 2024-113600

(51) Int. Cl. B65H 31/34; G03G 15/00

(52) U.S. Cl. CPC B65H 31/34; B65H 2301/4222; B65H 2801/27; G03G 15/6573

(57) ABSTRACT

A tamping apparatus includes a loader that has a shape of a plate extending from a first end to a second end and having a cutout at the first end, and that is configured to load media on a loading surface that is one plate surface, a support that is disposed near the second end and supports the media loaded onto the loading surface, and a tamper that is disposed near the first end of the loader and is switchable between a tamping position where a movement member reciprocates along the loading surface to tamp ends of the media near the first end and a withdrawal position where the movement member is withdrawn to a back side of the loader relative to the loading surface through the cutout.

### CROSS-REFERENCE TO RELATED APPLICATIONS

This application is based on and claims priority under 35 USC 119 from Japanese Patent Application No. 2024-113600 filed Jul. 16, 2024.

### BACKGROUND

### (i) Technical Field

The present disclosure relates to a tamping apparatus, a post-processing apparatus, and an image forming apparatus.

### (ii) Related Art

Japanese Unexamined Patent Application Publication No. 2017-105589 discloses a paper aligning apparatus, a post-processing apparatus, and an image forming apparatus that may perform a highly accurate aligning process on a plurality of paper sheets.

### SUMMARY

Aspects of non-limiting embodiments of the present disclosure relate to a tamping apparatus in which a structure in a direction intersecting a medium loading direction is more compact than in a structure in which withdrawal is performed only in the intersecting direction.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a tamping apparatus comprising: a loader that has a shape of a plate extending from a first end to a second end and having a cutout at the first end, and that is configured to load media on a loading surface that is one plate surface; a support that is disposed near the second end and supports the media loaded onto the loading surface; and a tamper that is disposed near the first end of the loader and is switchable between a tamping position where a movement member reciprocates along the loading surface to tamp ends of the media near the first end and a withdrawal position where the movement member is withdrawn to a back side of the loader relative to the loading surface through the cutout.

### BRIEF DESCRIPTION OF THE DRAWINGS

An exemplary embodiment of the present disclosure will be described in detail based on the following figures, wherein:

FIG. 1 is a front view illustrating an overview of an image forming system according to an exemplary embodiment of the present disclosure;

FIG. 2 is a side view of a pre-processor of the exemplary embodiment;

FIG. 3 conceptually illustrates a lead tamper of the exemplary embodiment when a movement member moves to a standby position and when the movement member moves to an aligning position;

FIGS. 4A and 4B are perspective views illustrating one movement member of the exemplary embodiment, in which FIG. 4A illustrates a relationship between the movement member and a recording medium before tamping at the aligning position, and FIG. 4B illustrates a relationship between the movement member and the recording medium that is being tamped at the aligning position;

FIGS. 5A to 5D conceptually illustrate variations of switching of the movement member of the exemplary embodiment between the standby position and a withdrawal position, in which FIG. 5A illustrates first specifications in which the movement member moves along a loading direction of the recording medium, FIG. 5B illustrates second specifications in which the movement member rotates, FIG. 5C illustrates third specifications in which the movement member rotates in a direction different from that in FIG. 5B, and FIG. 5D illustrates fourth specifications in which the movement member has a structure that converts linear movement into rotational movement;

FIG. 6 is a perspective view illustrating a state in which the movement member having the fourth specifications of the exemplary embodiment is at the standby position;

FIG. 7 illustrates a first end face of the movement member in FIG. 6;

FIG. 8 is a perspective view illustrating a state in which the movement member having the fourth specifications of the exemplary embodiment is at the withdrawal position;

FIG. 9 illustrates the first end face of the movement member in FIG. 8;

FIG. 10 is a partial sectional view illustrating a rotation preventing structure at the standby position;

FIG. 11A is a perspective view illustrating a state in which the movement member having the fourth specifications is located at the standby position;

FIG. 11B is a perspective view illustrating a state in which the movement member in the state of FIG. 11A moves in an arrow M1 direction;

FIG. 11C is a perspective view illustrating a state in which the movement member in the state of FIG. 11B rotates;

FIG. 11D is a perspective view illustrating a state in which the movement member in the state of FIG. 11C further rotates and is located at the withdrawal position;

FIG. 12A is a perspective view illustrating a state in which the movement member having the fourth specifications in the state of FIG. 11D moves in an arrow M2 direction;

FIG. 12B is a perspective view illustrating a state in which the movement member in the state of FIG. 12A rotates while moving in the arrow M2 direction; and

FIG. 12C is a perspective view illustrating a state in which the movement member in the state of FIG. 12B further rotates while moving in the arrow M2 direction and is located at the standby position.

### DETAILED DESCRIPTION

### Configuration of Exemplary Embodiment

An exemplary embodiment of the present disclosure is described below with reference to the drawings.

### <Image Forming System>

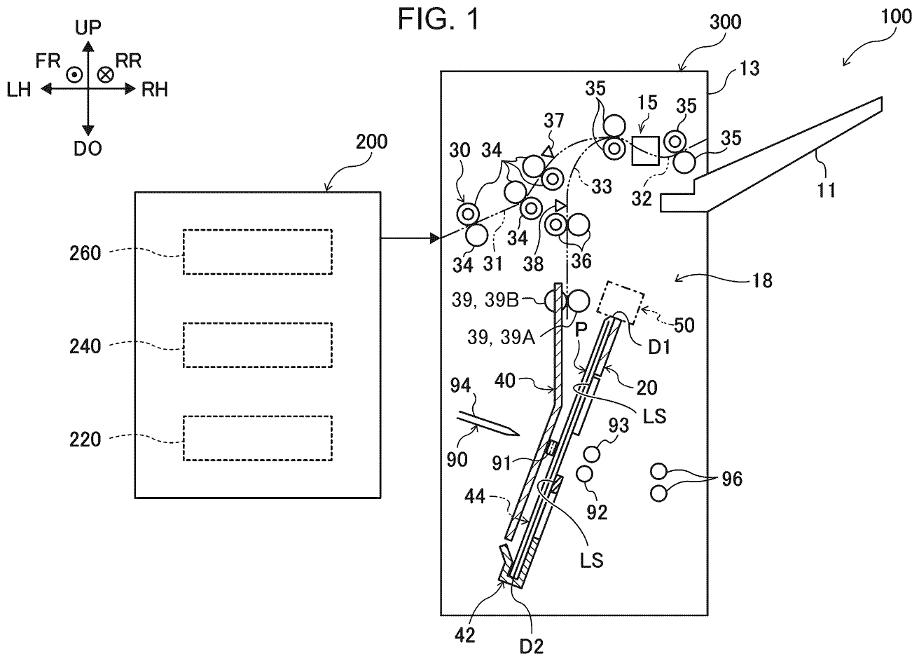

The configuration of an image forming system 100 according to this exemplary embodiment is described. FIG. 1 schematically illustrates the configuration of the image forming system 100 according to this exemplary embodiment.

In the figures, an arrow UP indicates an upward direction of the image forming system. An arrow DO indicates a downward direction of the image forming system. An arrow LH indicates a leftward direction of the image forming system. An arrow RH indicates a rightward direction of the image forming system. An arrow FR indicates a forward direction of the image forming system. An arrow RR indicates a rearward direction of the image forming system. These directions are defined for convenience of the description, and therefore the system configuration is not limited to these directions. When mentioning each direction of the image forming system, the term “image forming system” may be omitted. For example, “upward direction of image forming system” may be simplified as “upward direction.”

In the figures, an arrow M1 indicates a direction including components of both the arrows UP and RH, and indicates a specific direction in which a recording medium P is transported. An arrow M2 indicates a direction opposite to the direction of the arrow M1. An arrow L1 indicates a direction including components of both the arrows UP and LH, and indicates a specific direction in which the recording medium P is loaded. An arrow L2 indicates a direction opposite to the direction of the arrow L1. The arrows M1 and M2 are orthogonal to the arrows L1 and L2.

In the figures, the dimensional ratio of components may be different from the actual dimensional ratio.

The image forming system 100 illustrated in FIG. 1 forms an image on the recording medium P, and includes an image forming apparatus 200 and a post-processing apparatus 300. The components of the image forming system 100 (specifically the image forming apparatus 200 and the post-processing apparatus 300) are described. The recording medium P is an example of “medium.”

### <<Image Forming Apparatus>>

The image forming apparatus 200 forms an image on the recording medium P. The image forming apparatus 200 includes a paper feeder 220, an image former 240, and an outputter 260. The image forming apparatus 200 is, for example, an electrophotographic image forming apparatus that forms an image on the recording medium P using toner.

For example, the paper feeder 220 feeds the recording medium P.

For example, the image former 240 performs charging, exposing, developing, and transfer and fixing to the recording medium P.

For example, the outputter 260 outputs the recording medium P on which an image is formed. If post-processing is performed after the output, the outputter 260 feeds the recording medium P to the post-processing apparatus 300.

The image forming apparatus 200 is not limited to the electrophotographic image forming apparatus and may be, for example, an inkjet image forming apparatus or various other image forming apparatuses 200. The inkjet image forming apparatus 200 forms an image on the recording medium P by, for example, causing an ejector (not illustrated) to eject ink droplets to the recording medium P.

### <<Post-Processing Apparatus>>

The post-processing apparatus 300 illustrated in FIG. 1 performs post-processing on the recording medium P on which an image is formed by the image forming apparatus 200. Specifically, the post-processing apparatus 300 includes a post-processing apparatus body 13, an outputter 11, a first post-processor 15, a transport mechanism 30, a pre-processor 18, and a second post-processor 90. The components of the post-processing apparatus 300 (specifically the post-processing apparatus body 13, the outputter 11, the first post-processor 15, the transport mechanism 30, the pre-processor 18, and the second post-processor 90) are described.

### <<Post-Processing Apparatus Body 13, Outputter 11, and First Post-Processor 15>>

The post-processing apparatus body 13 includes the components of the post-processing apparatus 300. Specifically, the post-processing apparatus body 13 is a box-shaped (e.g., substantially rectangular parallelepiped) housing.

In this exemplary embodiment, the post-processing apparatus body 13 includes, for example, the first post-processor 15, the transport mechanism 30, the pre-processor 18, and the second post-processor 90. The outputter 11 is provided on the right side of the post-processing apparatus body 13.

The outputter 11 is disposed on the upper right side of the post-processing apparatus body 13. The recording medium P post-processed by the first post-processor 15 is output to the outputter 11.

The post-processing is performed on the recording medium P on which an image is formed. The post-processing to be performed by the first post-processor 15 includes a binding process for binding a plurality of recording media P with a stapler. The post-processing is not limited to the binding process. The post-processing may be any process to be performed on the recording medium P on which an image is formed, such as a cutting process for cutting the recording medium P or a punching process for punching the recording medium P.

### <<<Transport Mechanism>>>

As illustrated in FIG. 1, the transport mechanism 30 transports the recording medium P to the outputter 11 or the pre-processor 18. The transport mechanism 30 includes a first path 31, a second path 32, a third path 33, transport rollers 34, 35, and 36, a first detector 37, a second detector 38, and transport rollers 39. If the recording medium P is transported to the outputter 11, the transport mechanism 30 transports the recording medium P having passed through the first path 31 to the outputter 11 by forward rotation of the transport rollers 35 on the second path 32. If the recording medium P is transported to the pre-processor 18, the transport mechanism 30 transports the recording medium P having passed through the first path 31 toward the pre-processor 18 by reverse rotation of the transport rollers 35 on the second path 32.

The third path 33 is a transport path along which the recording medium P from the second path 32 is transported. The transport rollers 36 and the second detector 38 are disposed on the third path 33. The second detector 38 detects the end (e.g., the leading edge) of the recording medium P transported along the third path 33.

The plurality of transport rollers 36 may perform forward and reverse rotations, and may switch back the recording medium P on the third path 33. By the forward rotation of the plurality of transport rollers 36, the recording medium P is transported to the pre-processor 18.

By the reverse rotation of the transport rollers 36, the recording medium P switched back on the third path 33 is transported to the second path 32. The transport rollers 36 may control the transport speed of the recording medium P. Based on the detection result from the second detector 38, the transport rollers 36 may control the transport timing for transporting the recording medium P to the second path 32.

In the transport mechanism 30, the recording medium P transported from the image forming apparatus 200 to the first path 31, the second path 32, and the third path 33 in this order is transported to the pre-processor 18.

The transport rollers 39 are components that transport each of the plurality of recording media P transported from the transport mechanism 30.

In this exemplary embodiment, the transport rollers 39 transport the recording medium P downward. The transport rollers 39 include a driving roller 39A and a driven roller 39B. The pair of rollers transports the recording medium P by nipping it therebetween. The driving roller 39A is disposed closer to the outputter 11 (right side in this exemplary embodiment) than is the driven roller 39B. The driven roller 39B is disposed opposite to the outputter 11 (left side in this exemplary embodiment) across the driving roller 39A.

### <<<Pre-Processor>>>

As illustrated in FIG. 1, the pre-processor 18 performs pre-processing on the recording medium P transported by the transport mechanism 30. The pre-processing is alignment of the ends of a plurality of recording media P in an up-down direction and a front-rear direction prior to a process to be performed by the second post-processor 90. The pre-processor 18 includes a loader 20, a guide 40, a support 42, a side tamper 44, and a lead tamper 50. The pre-processor 18 is an example of “tamping apparatus.”

### <<<<Loader>>>>

As illustrated in FIG. 1, the loader 20 loads the recording medium P. In this exemplary embodiment, the loader 20 is a plate-shaped component inclined from the vertical direction in a front sectional view. The loader 20 has loading surfaces LS divided up and down while being inclined from the vertical direction, and is provided below the transport rollers 39. In the loader 20, the recording medium P transported by the transport rollers 39 is loaded onto the loading surfaces LS with the first end of the recording medium P (hereinafter referred to as “lower end D2”) oriented downward.

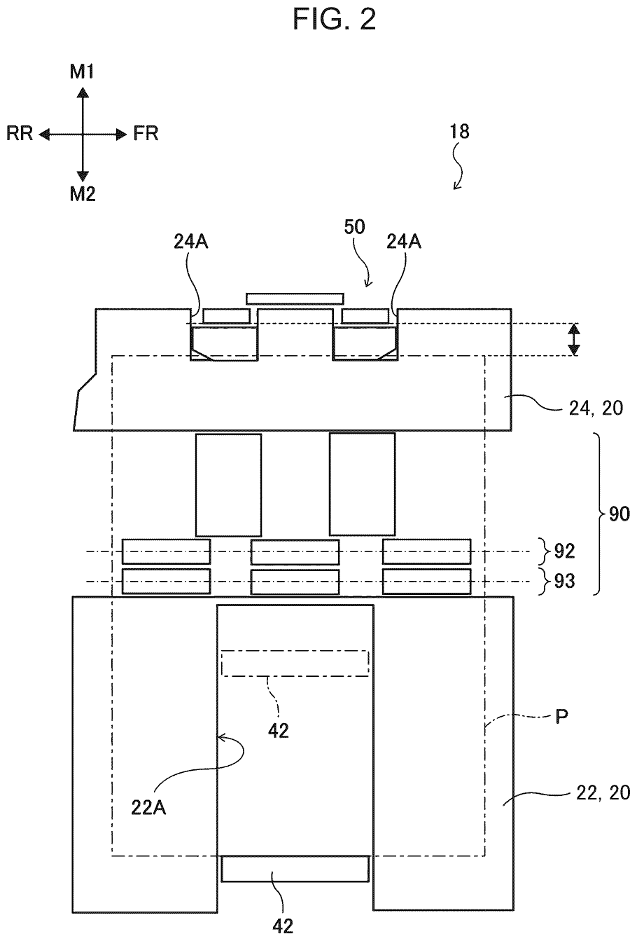

As illustrated in FIG. 2, the loader 20 includes a first loader 22 and a second loader 24. The loading surfaces LS are disposed on a common imaginary plane while being divided for the lower first loader 22 and the upper second loader 24. That is, when the recording medium P is loaded onto the loader 20, the recording medium P is loaded flat on the loading surfaces LS.

The first loader 22 is a plate-shaped component having a cutout 22A at part of the central portion in the front-rear direction, and serves as a lower part of the loader 20. The lower end D2 of the recording medium P is loaded onto the loading surface of the first loader 22 (lower loading surface LS of the loader 20).

The second loader 24 is a plate-shaped component having cutouts 24A at the end in the arrow M1 direction, and serves as an upper part of the loader 20. The second loader 24 is disposed above the first loader 22. An upper end D1 of the recording medium P is loaded onto the loading surface of the second loader 24 (upper loading surface LS of the loader 20). The second loader 24 is an example of “loader.” The upper end D1 is an end of the recording medium P opposite to the lower end D2.

### <<<<Guide>>>>

As illustrated in FIG. 1, the guide 40 is a component that guides the recording medium P transported by the transport rollers 39. In this exemplary embodiment, the guide 40 is a plate-shaped component inclined from the vertical direction. The guide 40 has a guide surface that is inclined from the vertical direction and faces the loading surfaces LS of the loader 20. In the guide 40, the guide surface guides the recording medium P to the loading surfaces LS of the loader 20. The guide 40 has a passing hole (not illustrated) through which a knife 94 passes.

### <<<<Support>>>>

As illustrated in FIG. 1, the support 42 is a component that supports the lower end D2 of the recording medium P loaded onto the loading surfaces LS of the loader 20. The support 42 is disposed below the loader 20. When the lower ends D2 of a plurality of recording media P loaded onto the loading surfaces LS of the loader 20 hit the support 42, the lower ends D2 are aligned.

As illustrated in FIG. 2, the support 42 may move in the arrow M1 direction or the arrow M2 direction and stop depending on the size of the recording medium P. In this exemplary embodiment, the support 42 moves on the inner side of the cutout 22A of the first loader 22.

### <<<<Side Tamper>>>>

As illustrated in FIG. 1, the side tamper 44 is a component that aligns the side ends of the recording media P with their surfaces placed on the loader 20 and their lower ends D2 placed on the support 42. The side tamper 44 is disposed below the transport rollers 39. The side tamper 44 includes a pair of approaching and separating portions (not illustrated). The pair of approaching and separating portions is disposed away from each other in the front-rear direction while facing each other. When the first approaching and separating portion repeatedly approaches and separates from the second approaching and separating portion, the pair of approaching and separating portions tamps the side ends of the recording media P to align the side ends of the recording media P.

### <<<<Lead Tamper>>>>

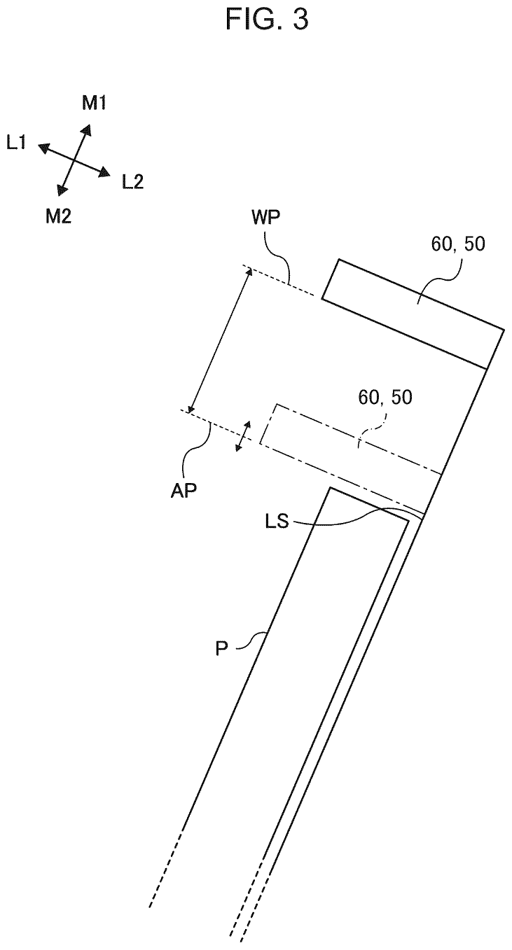

As illustrated in FIGS. 1 and 3, the lead tamper 50 is disposed above the loader 20, and performs a tamping action. The lead tamper 50 includes a movement member 60. The lead tamper 50 tamps the upper ends D1 of the recording media P downward to cause the lower ends D2 to hit the support 42. Thus, the upper ends D1 of the recording media P (i.e., the positions of the recording media P in the up-down direction) are aligned. The lead tamper 50 is an example of “tamper.”

As illustrated in FIG. 3, the movement member 60 of the lead tamper 50 pushes the upper ends D1 of the recording media P downward by repeating contact with the recording media P loaded onto the loading surfaces LS of the loader 20 along with reciprocal movement in the arrow M1 direction and the arrow M2 direction. That is, the movement member 60 pushes the upper ends D1 of the recording media P downward by tamping the upper ends D1 of the recording media P. The movement member 60 reciprocates in the arrow M1 direction and the arrow M2 direction by a slide mechanism such as a linear movement panel 52 described later.

The lead tamper 50 is switched between an aligning position AP and a standby position WP. The aligning position AP is a position where the movement member 60 reciprocates along the loading surface LS to tamp the upper ends D1 of the recording media P. The standby position WP is on the arrow M1 side of the aligning position AP, and the movement member 60 stands by at the standby position WP. The upper end D1 of the recording medium P is an example of “end of medium near first end.” The aligning position AP is an example of “tamping position.” Details of the lead tamper 50 are described later.

### <<<Second Post-Processor 90>>>

As illustrated in FIG. 1, the second post-processor 90 is a component that performs post-processing on the recording media P loaded onto the loading surfaces LS of the loader 20. The second post-processor 90 is an example of “processor.” In this exemplary embodiment, the second post-processor 90 performs, as the post-processing, a process of binding and folding a plurality of recording media P.

As illustrated in FIGS. 1 and 2, the second post-processor 90 includes a binder 91, a pair of folding rollers 92 and 93, the knife 94, and output rollers 96. The binder 91 is a so-called stapler that binds a plurality of recording media P loaded onto the loading surfaces LS of the loader 20 by stapling the centers of the plurality of recording media P in the up-down direction.

The pair of folding rollers 92 and 93 is disposed on a lower right side of a passing hole in the loading surfaces LS of the loader 20, and is arranged obliquely upward to the right. The folding rollers 92 and 93 rotate individually. As illustrated in FIG. 2, three sets of folding rollers 92 and 93 are arranged in the front-rear direction in this exemplary embodiment.

The length of the knife 94 is larger than the length of the recording medium P in the front-rear direction. The knife 94 is tapered at the tip.

The knife 94 pushes the recording media P to fold the recording media P. Specifically, the knife 94 moves obliquely downward to the right orthogonally to the guide 40. Then, the tip of the knife 94 is pushed against the center in the up-down direction that is a fold line of the plurality of recording media P. When the knife 94 pushes the center between the pair of folding rollers 92 and 93, the plurality of recording media P is nipped and folded by the pair of folding rollers 92 and 93.

When the pair of folding rollers 92 and 93 rotates, the folded recording media P are transported to the output rollers 96. The output rollers 96 transport the plurality of recording media P folded by the pair of folding rollers 92 and 93 and the knife 94 to output the recording media P to an outputter (not illustrated).

The post-processing to be performed by the second post-processor 90 is not limited to the above process. The post-processing may be, for example, a binding process for binding a plurality of recording media P or a folding process for folding a plurality of recording media P. The post-processing may be any process to be performed on the recording media P on which images are formed, such as a cutting process for cutting the recording media P or a punching process for punching the recording media P.

(Description about Principal Part)

The principal part of this exemplary embodiment is described. The lead tamper 50 is switched between the standby position WP and a withdrawal position EP. The withdrawal position EP is a position where the movement member 60 is withdrawn to the back side of the loader 20 (arrow L2) relative to the loading surface LS through the cutout 24A of the second loader 24. That is, the withdrawal position EP is a position where the movement member 60 is withdrawn to the back side of the loader 20 relative to the loading surface LS of the loader 20 so as not to hinder the movement of the recording media P on the loading surface LS.

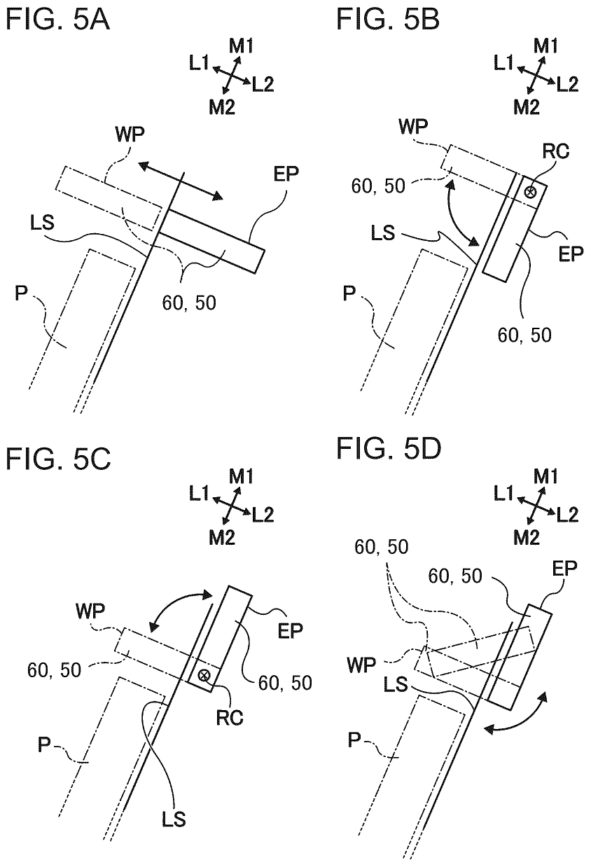

As illustrated in FIGS. 5A to 5D, the lead tamper 50 has four variations of switching between the standby position WP and the withdrawal position EP. Specifications of the variations are described.

In first specifications illustrated in FIG. 5A, the lead tamper 50 is switched between the standby position WP and the withdrawal position EP by sliding the movement member 60 along the loading direction of the recording medium P. Specifically, during the withdrawal, the lead tamper 50 slides the movement member 60 in the arrow L2 direction from the standby position WP on the loading surface LS of the loader 20 to the withdrawal position EP on the back side of the loading surface LS. During return to the standby position WP, the lead tamper 50 slides the movement member 60 in the arrow L1 direction from the withdrawal position EP to the standby position WP. The term “return” refers to switching from the withdrawal position EP to the standby position WP or switching from the withdrawal position EP to the aligning position AP via the standby position WP.

In second specifications illustrated in FIG. 5B, the lead tamper 50 is switched between the standby position WP and the withdrawal position EP by rotating the movement member 60 about a rotation axis RC. Specifically, during the withdrawal, the lead tamper 50 rotates the movement member 60 about the rotation axis RC from the standby position WP on the loading surface LS of the loader 20 to the withdrawal position EP on the arrow M2 side (near the recording medium P). During the return to the standby position WP, the lead tamper 50 rotates the movement member 60 about the rotation axis RC from the withdrawal position EP to the standby position WP on the arrow M1 side (away from the recording medium P).

In third specifications illustrated in FIG. 5C, the lead tamper 50 is switched between the standby position WP and the withdrawal position EP by rotating the movement member 60 about the rotation axis RC. Specifically, during the withdrawal, the lead tamper 50 rotates the movement member 60 about the rotation axis RC from the standby position WP on the loading surface LS of the loader 20 to the withdrawal position EP on the arrow M1 side (away from the recording medium P). During the return to the standby position WP, the lead tamper 50 rotates the movement member 60 about the rotation axis RC from the withdrawal position EP to the standby position WP on the arrow M2 side (near the recording medium P).

In fourth specifications illustrated in FIG. 5D, the lead tamper 50 is switched between the standby position WP and the withdrawal position EP by sliding the movement member 60 while rotating the movement member 60.

In the ways described above, the lead tamper 50 is switched between the aligning position AP and the withdrawal position EP via the standby position WP to move the movement member 60 to each position.

A specific example of the fourth specifications of this exemplary embodiment is described.

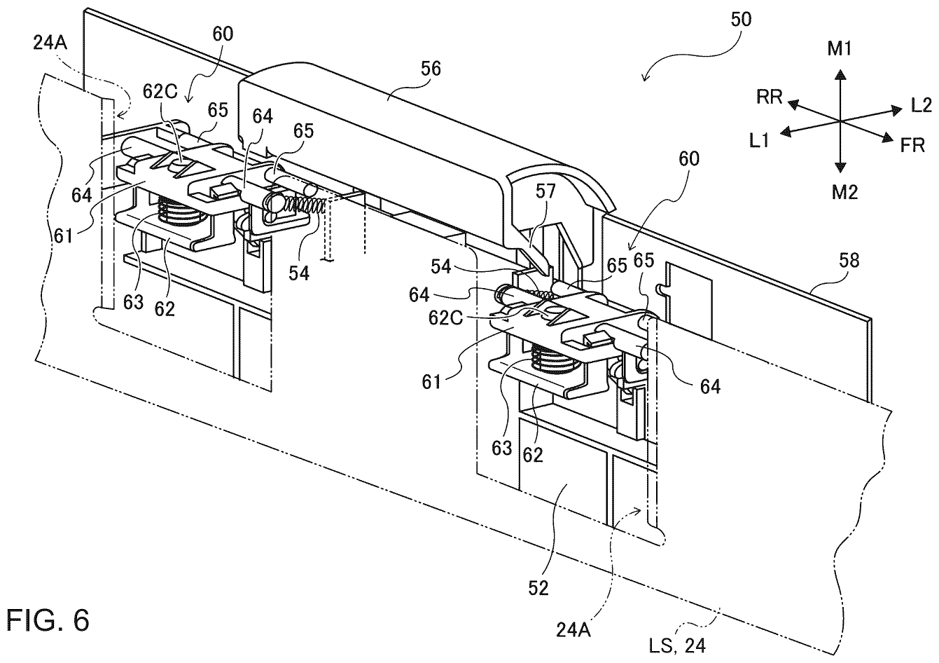

As illustrated in FIG. 6, the lead tamper 50 having the fourth specifications includes a fixed panel 58, the linear movement panel 52, the movement member 60, a second spring 54, and a stopper 56.

The fixed panel 58 is a plate extending along the front-rear direction and the arrow M1 direction, disposed on the arrow L2 side relative to the loading surface LS, and fixed to the second loader 24. A drive mechanism (not illustrated) is attached to the fixed panel 58. For example, the drive mechanism includes a motor having a pinion attached to the shaft.

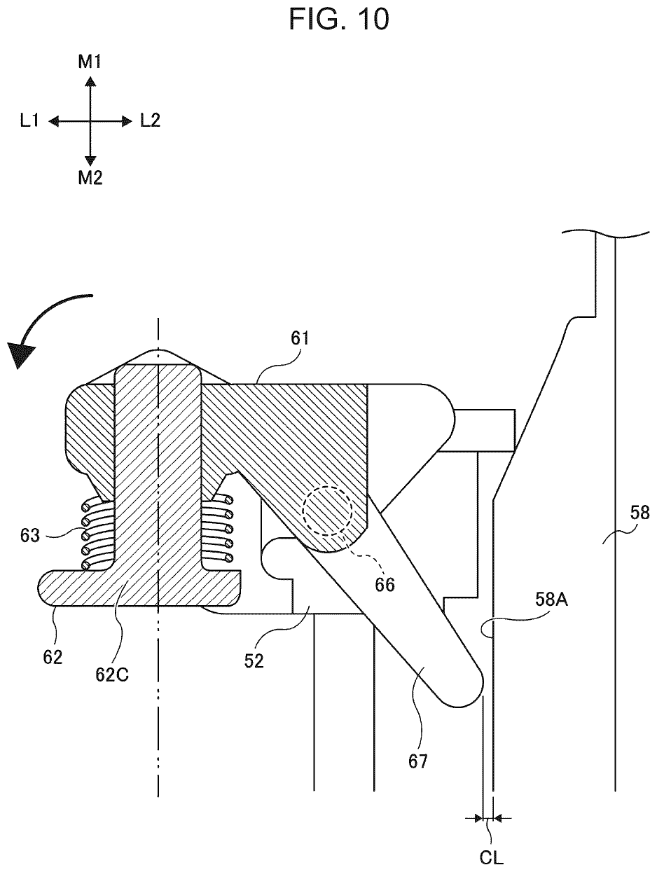

As illustrated in FIG. 10, the fixed panel 58 includes a raised portion 58A that is raised by bending part of the plate-shaped portion in the arrow L1 direction.

As illustrated in FIG. 6, the linear movement panel 52 is a plate-shaped component extending in the front-rear direction and in the arrow M1 direction and the arrow M2 direction. The linear movement panel 52 is disposed between the second loader 24 and the fixed panel 58. The linear movement panel 52 is movable in the arrow M1 direction and the arrow M2 direction relative to the fixed panel 58 by the drive mechanism (not illustrated). For example, the linear movement panel 52 is movable relative to the fixed panel 58 by the drive mechanism that operates by intermeshing between a rack (not illustrated) on the linear movement panel 52 and the pinion on the fixed panel 58. The linear movement panel 52 is an example of “linear movement member.”

When the linear movement panel 52 slides by a first movement amount along the loading surface LS relative to the fixed panel 58 by the drive mechanism, the lead tamper 50 is switched between the standby position WP and the aligning position AP. When the linear movement panel 52 slides by a second movement amount different from the first movement amount along the loading surface LS relative to the fixed panel 58 by the drive mechanism, the lead tamper 50 is switched between the standby position WP and the withdrawal position EP.

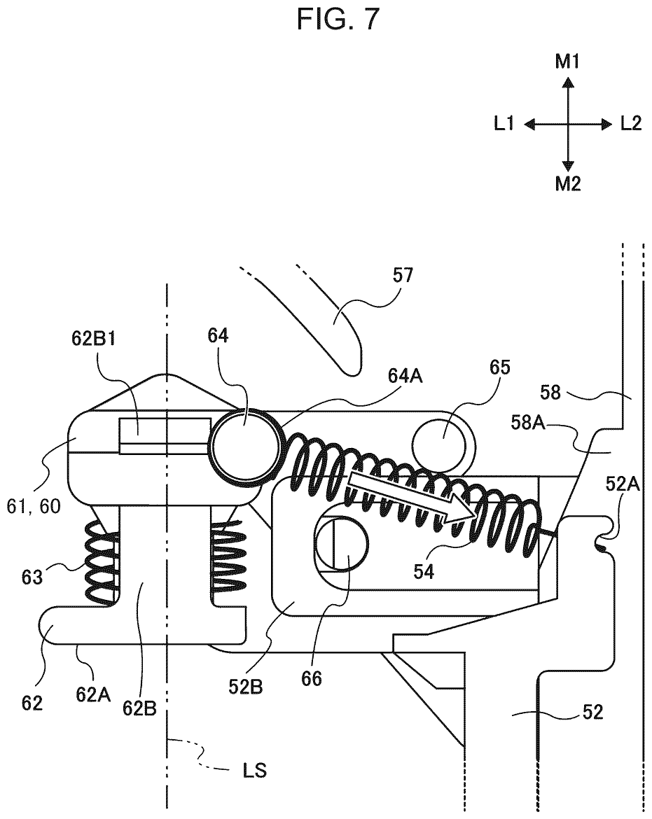

As illustrated in FIG. 7, the linear movement panel 52 rotatably supports the movement member 60 described later by a pair of support walls 52B projecting from the surface on the arrow L1 side. That is, the linear movement panel 52 is movable relative to the fixed panel 58 together with the movement member 60. The linear movement panel 52 has a groove 52A in the surface on the arrow L2 side.

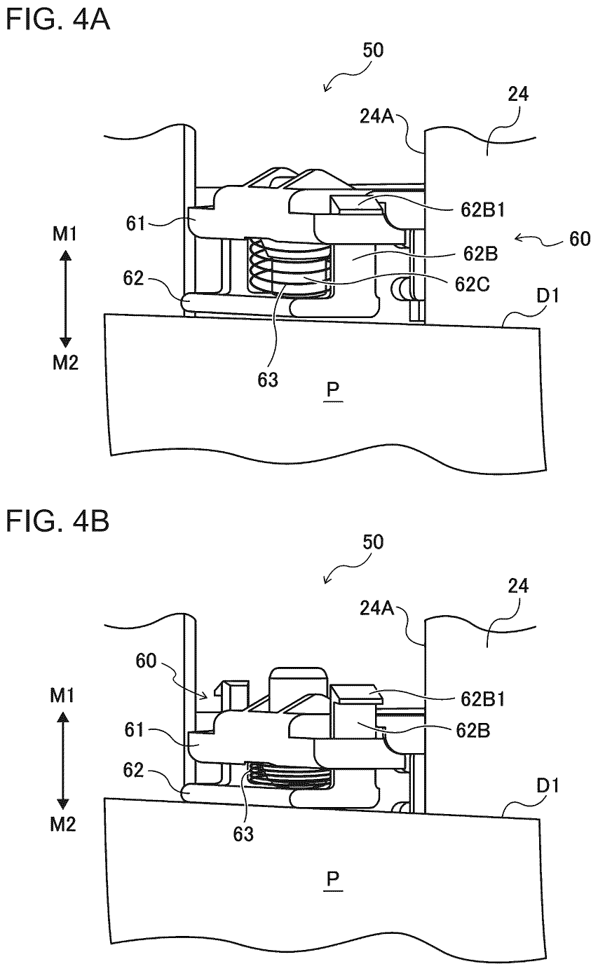

As illustrated in FIGS. 4A and 4B, the movement member 60 has a block shape with a plurality of projections and recesses, and is rotatably supported by the linear movement panel 52. The movement member 60 tamps the upper ends D1 of the recording media P while facing the upper ends D1. As illustrated in FIG. 6, a pair of movement members 60 is disposed on the upper side of the lead tamper 50 in the cutouts 24A at the upper end of the second loader 24 while being spaced away from each other in the front-rear direction.

The movement member 60 includes a body 61, a contact portion 62, a first spring 63, first rods 66, second rods 64, third rods 65, and a rotation stopper 67. The movement member is described under the assumption that the lead tamper 50 is located at the standby position WP unless otherwise noted.

The body 61 has a block shape that is flat in the up-down direction, and has a plurality of through holes extending in the arrow M1 direction. The body 61 is supported by the linear movement panel 52 via the first rod 66 described later, and moves in the arrow M1 direction or the arrow M2 direction.

The contact portion 62 is disposed below the body 61, and is configured to come into contact with the upper ends D1 of the recording media P. As illustrated in FIGS. 6 and 7, the contact portion 62 includes a contact surface 62A, arms 62B, and a shaft 62C. The contact surface 62A is a rectangular surface that may come into contact with the upper ends D1 of the recording media P while facing the upper ends D1. The arms 62B are inserted through the through holes of the body 61 while extending in the arrow M1 direction from the back side of the contact surface 62A. A pair of arms 62B is disposed away from each other in the front-rear direction. The arm 62B has a protrusion 62B1 that may be hooked on the edge of the through hole of the body 61 while being inserted through the through hole. The shaft 62C extends in the arrow M1 direction from the back side of the contact surface 62A, and is disposed between the pair of arms 62B. The shaft 62C is movable in the through hole of the body 61 while being inserted through the through hole to guide movement of the contact portion 62 in the arrow M1 direction and the arrow M2 direction.

As illustrated in FIG. 6, the first spring 63 is an elastic member that has a first end supported by the body 61 and a second end supported by the contact portion 62 and is disposed in a compressed state between the body 61 and the contact portion 62. In this exemplary embodiment, the first spring 63 is a compression coil spring. The first spring 63 is disposed so as not to fall off with the shaft 62C inserted therethrough. The first spring 63 urges the contact portion 62 in the arrow M2 direction relative to the body 61. Before the recording media P are tamped at the aligning position AP as illustrated in FIG. 4A, the first spring 63 urges the contact portion 62 with the protrusions 62B1 of the contact portion 62 hooked on the edges of the through holes of the body 61. As illustrated in FIG. 4B, the first spring 63 is compressed as the contact portion 62 pushes the upper ends D1 of the recording media P in the arrow M2 direction at the aligning position AP.

As illustrated in FIG. 7, a pair of first rods 66 extends forward and rearward from both ends of the body 61 in the front-rear direction. The first rod 66 is disposed on the arrow L1 side of the groove 52A of the linear movement panel 52. The first rod 66 is rotatably supported by the support wall 52B of the linear movement panel 52. The first rod 66 serves as a rotation center during the withdrawal and return of the movement member 60.

As illustrated in FIG. 6, a pair of second rods 64 extends forward and rearward from both ends of the body 61 in the front-rear direction. The second rod 64 is disposed on the arrow L2 side of the through holes of the body 61 and the loading surface LS.

As illustrated in FIG. 7, the second rod 64 is disposed on the arrow M1 side and the arrow L1 side of the first rod 66. The second rod 64 projects forward or rearward from the body 61 more than the first rod projects. Grooves 64A are formed at both ends of the second rods 64 over the enter circumference of the second rods 64. The second rod 64 cooperates with the linear movement panel 52 and the stopper 56 described later to convert linear movement into rotational movement during the withdrawal of the movement member 60.

As illustrated in FIG. 6, a pair of third rods 65 extends forward and rearward from both ends of the body 61 in the front-rear direction. The third rod 65 is disposed on the arrow L2 side of the second rod 64. The length of the third rod 65 in the front-rear direction is set smaller than the length of the second rod 64 in the front-rear direction and larger than the length of the first rod 66 in the front-rear direction. The third rod 65 cooperates with the linear movement panel 52 and the stopper 56 described later to convert linear movement into rotational movement during the return of the movement member 60.

A structure that restricts the rotation of the movement member 60 is described. The rotation stopper 67 is a plate with its thickness direction corresponding to the front-rear direction. As illustrated in FIG. 10, the rotation stopper 67 extends in the arrow L2 direction and the arrow M2 direction from the end of the body 61 on the arrow L2 side. The rotation stopper 67 is disposed at the center of the body 61 in the front-rear direction, and faces the raised portion 58A of the fixed panel 58. The rotation stopper 67 comes into contact with the raised portion 58A at the aligning position AP and the standby position WP to stop the rotation of the movement member 60 to the arrow M2 side. The rotation stopper 67 is an example of “regulating member.”

The length of the rotation stopper 67 is set to secure a clearance CL from the raised portion 58A when the movement member 60 is at the standby position WP.

The movement member 60 is structured as described above.

As illustrated in FIG. 7, the second spring 54 is an elastic member having a first end supported by the groove 64A of the second rod 64 of the movement member 60 and a second end supported by the groove 52A of the linear movement panel 52. The second spring 54 is an example of “urging member.” In this exemplary embodiment, the second spring 54 is an extension coil spring.

The second spring 54 urges the second rod 64 of the movement member 60 at the standby position WP in the arrow L2 direction and the arrow M2 direction so that a clockwise moment acts about the first rod 66. That is, the second spring 54 operates so that the movement member 60 together with the rotation stopper 67 keeps the standby position WP.

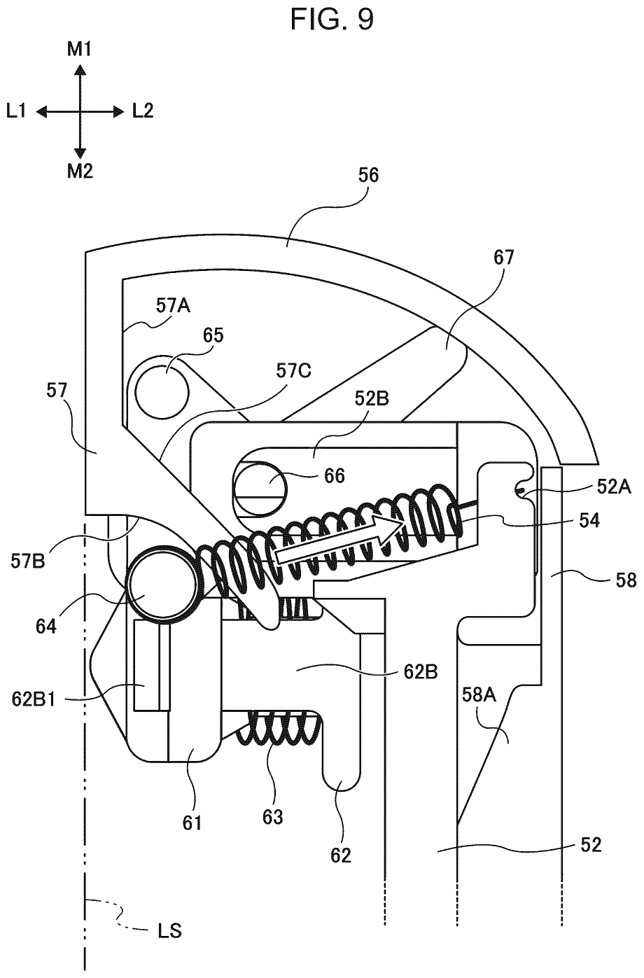

As illustrated in FIG. 9, the second spring 54 urges the second rod 64 of the movement member 60 at the withdrawal position EP in the arrow L2 direction and the arrow M1 direction so that a counterclockwise moment acts about the first rod 66. That is, the second spring 54 operates so that the movement member 60 together with the rotation stopper 67 keeps the withdrawal position EP.

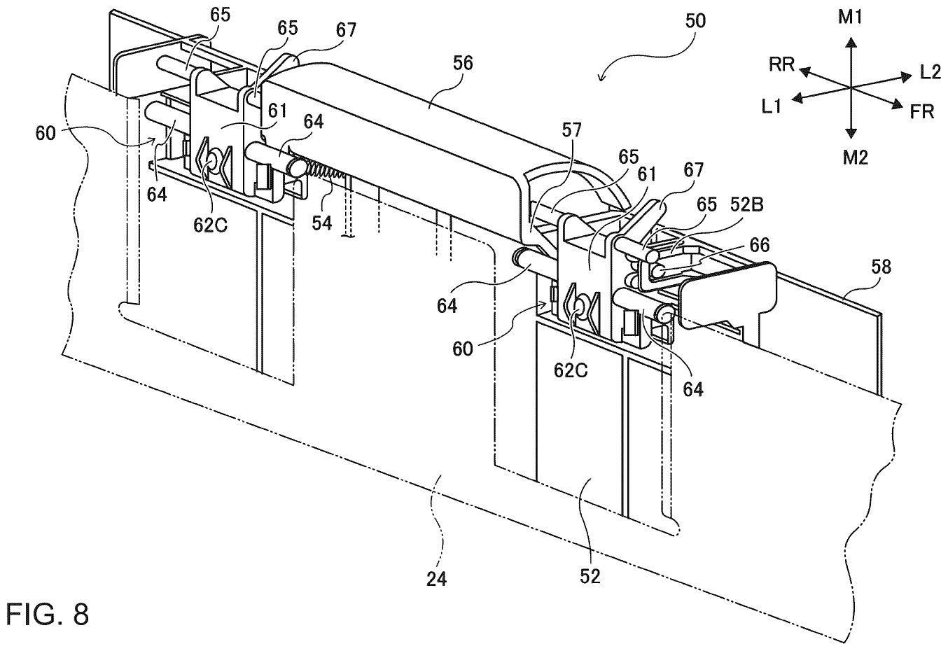

As illustrated in FIGS. 6 and 8, the stopper 56 is a member extending in the front-rear direction. The stopper 56 is fixed to the fixed panel 58. The stopper 56 stops the movement of the movement member 60 in the arrow M1 direction. Specifically, the stopper 56 includes projecting rails 57 at both ends in the front-rear direction. The stopper 56 is an example of “conversion member.”

As illustrated in FIG. 9, the rail 57 has a straight surface 57A, an outer inclined surface 57B, and an inner inclined surface 57C.

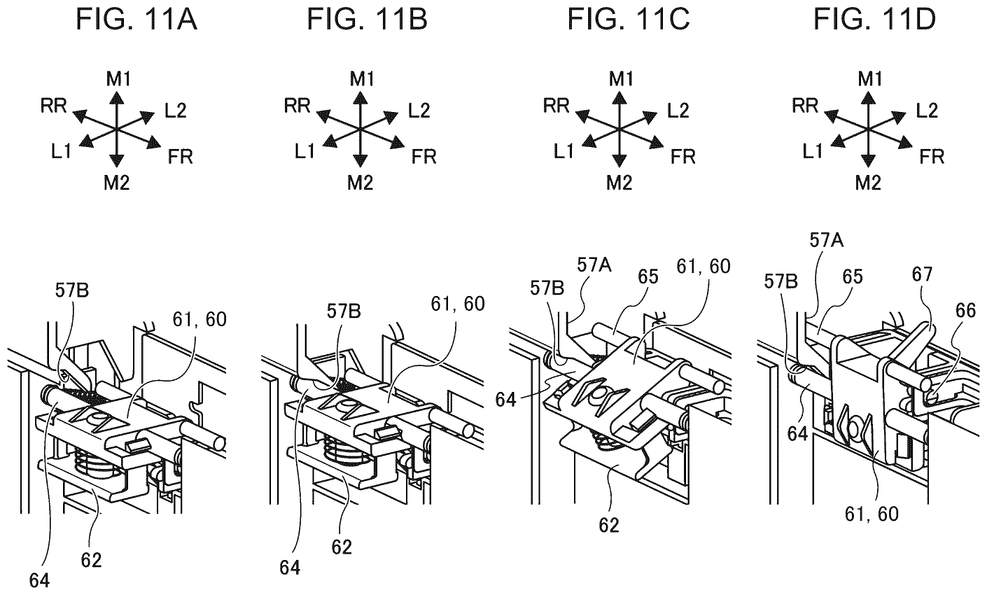

The straight surface 57A faces the fixed panel 58 along the arrow M1 direction, and is positioned on the arrow L2 side of the loading surface LS of the second loader 24. As illustrated in FIG. 11D, the straight surface 57A stops the rotation of the movement member 60 by coming into contact with the third rod 65 when the movement member 60 is withdrawn.

As illustrated in FIG. 9, the outer inclined surface 57B extends from the straight surface 57A in the arrow M2 direction and the arrow L2 direction, and faces the second loader 24. The outer inclined surface 57B comes into contact with the second rod 64 when the movement member 60 is switched from the standby position WP to the withdrawal position EP.

The inner inclined surface 57C extends from the straight surface 57A in the arrow M2 direction and the arrow L2 direction, and faces the linear movement panel. The inner inclined surface 57C comes into contact with the third rod 65 when the movement member 60 returns from the withdrawal position EP to the standby position WP.

The stopper 56 is structured as described above.

The lead tamper 50 having the fourth specifications is structured as described above.

### Operations

The operations of this exemplary embodiment are described using the fourth specifications.

[Withdrawal from Standby Position WP to Withdrawal Position]

The withdrawal from the standby position WP to the withdrawal position EP is described with reference to FIGS. 11A to 11D. As illustrated in FIG. 11A, the movement member 60 is located at the standby position WP.

As illustrated in FIG. 11B, when the linear movement panel 52 moves in the arrow M1 direction relative to the fixed panel 58, one of the second rods 64 of the movement member 60 comes into contact with the outer inclined surface 57B of the stopper 56.

As illustrated in FIG. 11C, the linear movement panel 52 further moves in the arrow M1 direction relative to the fixed panel 58. Along with this movement, the contact portion 62 of the movement member 60 rotates toward the recording medium P and the third rod 65 rotates toward the straight surface 57A of the stopper 56 about the contact point between the second rod 64 and the outer inclined surface 57B.

When the linear movement panel 52 further moves in the arrow M1 direction relative to the fixed panel 58, the third rod 65 comes into contact with the straight surface 57A of the stopper 56 to stop the rotation of the movement member 60, thereby achieving the state illustrated in FIG. 11D.

In the way described above, the withdrawal from the standby position WP to the withdrawal position EP is completed.

[Return from Withdrawal Position to Standby Position]

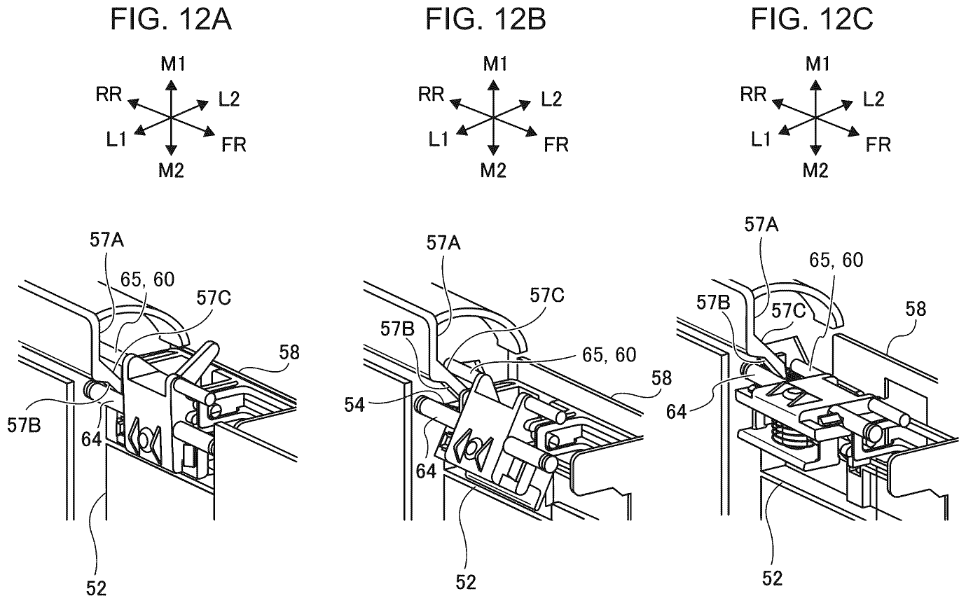

The return from the withdrawal position EP to the standby position WP is described with reference to FIGS. 11A to 12C.

As illustrated in FIG. 11D, the movement member 60 is located at the withdrawal position.

As illustrated in FIG. 12A, when the linear movement panel 52 moves in the arrow M2 direction relative to the fixed panel 58, the third rod 65 of the movement member 60 moves in the arrow M1 direction along the straight surface 57A of the stopper 56.

As illustrated in FIG. 12B, when the linear movement panel 52 further moves in the arrow M2 direction relative to the fixed panel 58, the third rod 65 moves from the straight surface 57A to an indeterminate position on the inner inclined surface 57C. At the indeterminate position, the second spring 54 is pulled and the movement member 60 rotates so that the second rod 64 approaches the outer inclined surface 57B in the process of further movement of the linear movement panel 52 in the arrow M2 direction.

As illustrated in FIG. 12C, when the linear movement panel 52 further moves in the arrow M2 direction relative to the fixed panel 58, the third rod 65 at the indeterminate position moves from the inner inclined surface 57C in the arrow L2 direction, and the rotation of the movement member 60 is stopped.

In the way described above, the return from the withdrawal position EP to the standby position WP is completed.

The pre-processor 18 of this exemplary embodiment includes: the second loader 24 that has the shape of the plate extending from the first end in the arrow M2 direction to the second end in the arrow M1 direction and having the cutout 24A at the first end, and that is configured to load the recording media P on the loading surface LS that is one plate surface; the support 42 that is disposed near the second end and supports the recording media P loaded onto the loading surface LS; and the lead tamper 50 that is disposed near the first end of the second loader 24 and is switchable between the aligning position AP where the movement member 60 reciprocates along the loading surface LS to tamp the ends of the recording media P near the first end and the withdrawal position EP where the movement member 60 is withdrawn to the back side of the second loader 24 relative to the loading surface LS through the cutout 24A.

In the pre-processor 18 of this exemplary embodiment, the lead tamper 50 is configured to withdraw the movement member 60 by rotating the movement member 60 in the first direction.

The pre-processor 18 of this exemplary embodiment includes the raised portion 58A of the fixed panel 58 that regulates the rotation direction of the movement member 60.

In the pre-processor 18 of this exemplary embodiment, the raised portion 58A of the fixed panel 58 restricts the rotation of the movement member 60 away from the second end of the loader 20.

In the pre-processor 18 of this exemplary embodiment, the lead tamper 50 includes: the linear movement panel 52 that is disposed on the back side of the loader 20 and is configured to cause the movement member 60 to perform linear movement along the loading surface LS; and the stopper 56 that is disposed at the first end of the loader 20 and is configured to convert the linear movement of the movement member 60 caused by the linear movement panel 52 into rotational movement.

In the pre-processor 18 of this exemplary embodiment, the lead tamper 50 is configured to return the movement member 60 to the aligning position AP or the standby position WP by rotating the movement member 60 in the second direction opposite to the first direction.

In the pre-processor 18 of this exemplary embodiment, the lead tamper 50 includes the second spring 54 that has the first end supported by the linear movement panel 52 and the second end supported by the movement member 60, and that is configured to urge the movement member 60 to keep the withdrawal position EP when the movement member 60 is located at the withdrawal position EP, and to urge the movement member 60 to keep the standby position WP when the movement member 60 is located at the standby position WP.

The post-processing apparatus 300 of this exemplary embodiment includes: the pre-processor 18 described above; and the second post-processor 90 configured to process the recording media P aligned by the pre-processor 18.

The image forming apparatus 200 of this exemplary embodiment includes: the image former 240 configured to form images on the recording media P; and the pre-processor 18 described above configured to align the recording media P on which the images are formed by the image former 240.

### Modifications

The pre-processor 18 may be applied to the post-processing apparatus 300 connected to the image forming apparatus 200, the inside of the image forming apparatus 200, or the outputter 260 of the image forming apparatus 200. The pre-processor 18 may be applied to, for example, the paper feeder 220 of the image forming apparatus 200 or a manual feeder (not illustrated).

The lead tamper 50 withdraws the movement member 60 to the withdrawal position EP by rotating the movement member 60 in the first direction, but the lead tamper 50 is not limited thereto. For example, the lead tamper 50 may rotate the movement member 60 in the second direction opposite to the first direction. The lead tamper 50 may withdraw the movement member 60 by sliding the movement member 60 from the standby position WP to the withdrawal position EP along the loading direction of the recording media P.

The pre-processor 18 includes the rotation stopper 67 that regulates the rotation direction of the movement member 60 included in the lead tamper 50, but the pre-processor 18 is not limited thereto. The pre-processor 18 may be applied to the lead tamper 50 having the second specifications in FIG. 5B or the third specifications in FIG. 5C.

The lead tamper 50 returns the movement member 60 to the aligning position AP or the standby position WP by rotating the movement member 60 in the second direction, but the lead tamper 50 is not limited thereto. For example, the lead tamper 50 may rotate the movement member 60 in the first direction.

The lead tamper 50 includes the second spring 54, but the lead tamper 50 is not limited thereto. For example, the lead tamper 50 may omit the second spring 54.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The exemplary embodiments were chosen and described in order to best explain the principles of the disclosure and its practical applications, thereby enabling others skilled in the art to understand the disclosure for various exemplary embodiments and with the various modifications as are suited to the particular use contemplated. It is intended that the scope of the disclosure be defined by the following claims and their equivalents.

### APPENDIX

(((1)))

A tamping apparatus comprising:
a loader that has a shape of a plate extending from a first end to a second end and having a cutout at the first end, and that is configured to load media on a loading surface that is one plate surface;
a support that is disposed near the second end and supports the media loaded onto the loading surface; and
a tamper that is disposed near the first end of the loader and is switchable between a tamping position where a movement member reciprocates along the loading surface to tamp ends of the media near the first end and a withdrawal position where the movement member is withdrawn to a back side of the loader relative to the loading surface through the cutout.
   (((2)))

The tamping apparatus according to (((1))), wherein the tamper is configured to withdraw the movement member by rotating the movement member in a first direction.

(((3)))

The tamping apparatus according to (((2))), further comprising a regulating member that regulates a rotation direction of the movement member.

(((4)))

The tamping apparatus according to (((3))), wherein the regulating member restricts rotation of the movement member away from the second end of the loader.

(((5)))

The tamping apparatus according to any one of (((2))) to (((4))), wherein the tamper comprises:
a linear movement member that is disposed on the back side of the loader and is configured to cause the movement member to perform linear movement along the loading surface; and
a conversion member that is disposed at the first end of the loader and is configured to convert the linear movement of the movement member caused by the linear movement member into rotational movement.
   (((6)))

The tamping apparatus according to (((5))), wherein the tamper is configured to return the movement member to the tamping position by rotating the movement member in a second direction opposite to the first direction.

(((7)))

The tamping apparatus according to (((6))), wherein the tamper comprises an urging member that has a first end supported by the linear movement member and a second end supported by the movement member, and that is configured to urge the movement member to keep the withdrawal position when the movement member is located at the withdrawal position, and to urge the movement member to keep the tamping position when the movement member is located at the tamping position.

(((8)))

A post-processing apparatus comprising:
the tamping apparatus according to any one of (((1))) to (((7))); and
a processor configured to process the media aligned by the tamping apparatus.
   (((9)))

An image forming apparatus comprising:
an image former configured to form images on media; and
the tamping apparatus according to any one of (((1))) to (((7))) configured to align the media on which the images are formed by the image former.

What is claimed is:

1. A tamping apparatus comprising:
a loader that has a shape of a plate extending from a first end to a second end and having a cutout at the first end, and that is configured to load media on a loading surface that is one plate surface;
a support that is disposed near the second end and supports the media loaded onto the loading surface; and
a tamper that is disposed near the first end of the loader and is switchable between a tamping position where a movement member reciprocates along the loading surface to tamp ends of the media near the first end and a withdrawal position where the movement member is withdrawn to a back side of the loader relative to the loading surface through the cutout.

2. The tamping apparatus according to claim 1, wherein the tamper is configured to withdraw the movement member by rotating the movement member in a first direction.

3. The tamping apparatus according to claim 2, further comprising a regulating member that regulates a rotation direction of the movement member.

4. The tamping apparatus according to claim 3, wherein the regulating member restricts rotation of the movement member away from the second end of the loader.

5. The tamping apparatus according to claim 2, wherein the tamper comprises:
a linear movement member that is disposed on the back side of the loader and is configured to cause the movement member to perform linear movement along the loading surface; and
a conversion member that is disposed at the first end of the loader and is configured to convert the linear movement of the movement member caused by the linear movement member into rotational movement.

6. The tamping apparatus according to claim 5, wherein the tamper is configured to return the movement member to the tamping position by rotating the movement member in a second direction opposite to the first direction.

7. The tamping apparatus according to claim 6, wherein the tamper comprises an urging member that has a first end supported by the linear movement member and a second end supported by the movement member, and that is configured to urge the movement member to keep the withdrawal position when the movement member is located at the withdrawal position, and to urge the movement member to keep the tamping position when the movement member is located at the tamping position.

8. A post-processing apparatus comprising:
the tamping apparatus according to claim 1; and
a processor configured to process the media aligned by the tamping apparatus.

9. A post-processing apparatus comprising:
the tamping apparatus according to claim 2; and
a processor configured to process the media aligned by the tamping apparatus.

10. A post-processing apparatus comprising:
the tamping apparatus according to claim 3; and
a processor configured to process the media aligned by the tamping apparatus.

11. A post-processing apparatus comprising:
the tamping apparatus according to claim 4; and
a processor configured to process the media aligned by the tamping apparatus.

12. A post-processing apparatus comprising:
the tamping apparatus according to claim 5; and
a processor configured to process the media aligned by the tamping apparatus.

13. A post-processing apparatus comprising:
the tamping apparatus according to claim 6; and
a processor configured to process the media aligned by the tamping apparatus.

14. A post-processing apparatus comprising:
the tamping apparatus according to claim 7; and
a processor configured to process the media aligned by the tamping apparatus.

15. An image forming apparatus comprising:
an image former configured to form images on media; and
the tamping apparatus according to claim 1 configured to align the media on which the images are formed by the image former.

16. An image forming apparatus comprising:
an image former configured to form images on media; and
the tamping apparatus according to claim 2 configured to align the media on which the images are formed by the image former.

17. An image forming apparatus comprising:
an image former configured to form images on media; and
the tamping apparatus according to claim 3 configured to align the media on which the images are formed by the image former.

18. An image forming apparatus comprising:
an image former configured to form images on media; and
the tamping apparatus according to claim 4 configured to align the media on which the images are formed by the image former.

19. An image forming apparatus comprising:
an image former configured to form images on media; and
the tamping apparatus according to claim 5 configured to align the media on which the images are formed by the image former.

20. An image forming apparatus comprising:
an image former configured to form images on media; and
the tamping apparatus according to claim 6 configured to align the media on which the images are formed by the image former.
